(19) United States
(12) Patent Application Publication
(10) Pub. No.: US 2025/0176462 A1
(43) Pub. Date: Jun. 5, 2025

(54) Header Flow Monitoring

(71) Applicant: AGCO International GmbH, Neuhausen (CH)

(72) Inventor: Dan Hermann, Randers (DK)

(21) Appl. No.: 18/833,590

(22) PCT Filed: Feb. 23, 2023
(86) PCT No.: PCT/IB2023/051669

§ 371 Date: Jul. 26, 2024

(30) Foreign Application Priority Data
Mar. 31, 2022 (GB) 2204632.0

(51) Int. Cl. A01D 41/127; A01D 41/02; A01D 41/06; A01D 45/02

(52) U.S. Cl. CPC A01D 41/1271; A01D 41/02; A01D 41/06; A01D 41/1278; A01D 45/028

(57) ABSTRACT

Systems and methods are provided for monitoring operation of an agricultural machine performing an agricultural operation. Image data from one or more image sensors is obtained and used to monitor operation of an implement operably coupled to the machine. The image data is used determine a crop parameter for each of one or more crop constituents indicative of the position and/or motion of the respective crop constituent with respect to the implement. A performance metric for the agricultural operation is determined in dependence on the determined crop parameter(s). One or more operable components associated with the machine can then be controlled in dependence on the determined performance metric.

### CROSS-REFERENCE TO RELATED APPLICATIONS

Not applicable.

### FIELD

Embodiments of the present disclosure relate generally to monitoring operation of an agricultural machine, and in particular, to monitoring flow of material into and/or through a harvesting implement, such as a header for a harvesting machine.

### BACKGROUND

In agricultural operations, such as harvesting of corn and the like, it is possible and indeed important to control multiple parameters to maximize the efficiency of the process and reduce losses experienced due to incorrect or inappropriate operating conditions. For instance, harvesting performance can depend on a distance between skid plates in row units, cutting/chain speed in row units and forward speed of the machine. Small changes in these parameters can significantly increase grain loss due to crop or constituents thereof (e.g. cobs) being thrown out of the header or crushed. Widths of headers for said machines can be up to and in some instances exceed 10 m. Accordingly, it is unrealistic for the operator alone to continuously supervise the full header (or parts thereof) whilst simultaneously attending numerous other tasks such as machine parameter adjustment, on the go un-loading, etc. Furthermore, given such tasks often take place over extended periods, e.g. all day, operator fatigue additionally reduces the operator awareness and reaction time. Accordingly, systems which reply on operator monitoring of the header performance can experience significant issues in terms of losses.

It would therefore be advantageous to provide means to assist an operator of such machines in monitoring operation of the crop engaging components thereof to minimize or at least reduce losses associated with the operation.

### BRIEF SUMMARY

In an aspect of the invention there is provided a control system for monitoring operation of an agricultural machine performing an agricultural operation, the control system comprising one or more controllers, and being configured to: receive image data from one or more image sensors mounted on or otherwise coupled to the agricultural machine and configured to capture image data representative of the operation of a crop-engaging component of the machine; determine, from the image data, a crop parameter for each of one or more crop constituents indicative of the position and/or motion of the respective crop constituent with respect to the crop-engaging component; determine a performance metric for the agricultural operation in dependence on the determined crop parameter(s); and generate and output control signals for controlling one or more operable components associated with the agricultural machine in dependence on the determined performance metric.

Advantageously, the control system is operable to identify and determine the position and/or motion of individual crop constituents, e.g. corn cobs or the like, and track such parameters during the agricultural operation. This can, in turn, provide an indication or may quantify performance of the operation.

The one or more controllers may collectively comprise an input (e.g. an electronic input) for receiving one or more input signals. The one or more input signals may comprise data indicative of the image data from the one or more image sensors. The one or more controllers may collectively comprise one or more processors (e.g. electronic processors) operable to execute computer readable instructions for controlling operational of the control system, for example, to determine the crop parameter and/or performance metric. The one or more processors may be operable to generate one or more control signals for controlling operation of the one or more operable components. The one or more controllers may collectively comprise an output (e.g. an electronic output) for outputting the one or more control signals.

The control system may be configured to analyse the image data from the one or more image sensors and identify therein one or more individual crop constituents. The control system may be configured to determine the crop parameter(s) for the individual crop constituent(s) in dependence on the identification.

The crop parameter may comprise a position of the crop constituent(s). The crop parameter may comprise a position of the crop constituent(s) within the image data. The crop parameter may comprise a position of the crop constituent(s) with respect to the crop engaging component.

The crop parameter may comprise a measure of a movement of the crop constituent(s). The crop parameter may comprise a measure of a movement of the crop constituent(s) within the image data from the one or more image sensors. The crop parameter may comprise a measure of a movement of the crop constituent(s) with respect to the crop engaging component. The measure of the movement of the crop constituent(s) may comprise a measure of the direction, speed and or distance of travel of the crop constituent(s).

Advantageously, the control system may be configured to determine from the movement of the crop constituent(s) a measure of the performance of the agricultural operation. For example, this may include identifying whether the movement of the crop constituent(s) follows an expected path for the monitored agricultural operation and/or the crop engaging component used. This may include determining whether a path travelled by a crop constituent follows an expected path for the operation and/or the particular crop engaging component.

The control system may be configured to identify an anomalous crop constituent in dependence on a measure of movement for that constituent deviating from the expected path for the monitored agricultural operation or crop engaging component. The control system may be configured to identify an anomalous crop constituent in dependence on an unexpected change in the direction and/or speed of travel of the crop constituent. Such a motion may be indicative of the respective crop constituent exiting the crop engaging component and not being collected/harvested by the agricultural machine. Accordingly, identifying such movements may advantageously provide a measure of loss for the agricultural operation.

The crop parameter may comprise a size of the crop constituent(s). The control system may be configured to analyse the image data and determine or identify therefrom a change in size of the crop constituent(s) during the collection/harvesting of the crop constituent(s) by the agricultural machine—e.g. upon interaction of the crop constituent(s) with the crop engaging component. A change in size of a crop constituent may be indicative of a breakage of the crop constituent. Accordingly, the control system may be configured to determine an anomalous crop constituent in dependence on a change in size of the respective component during collection/harvest by the machine. The control system may be configured to compare the identified change in size with a threshold and determine an anomalous constituent in dependence on the comparison. Broken crop constituents in turn may contribute to a loss for the agricultural operation and as such, monitoring or identifying instances of such breakages may advantageously provide a measure of loss for the operation.

The performance metric may quantify performance of the agricultural machine performing the operation. The performance metric may correspond to a measure (e.g. a relative measure) of ground loss for the agricultural operation.

The performance metric may comprise a count of anomalous crop constituent(s). The performance metric may comprise a relative measure of anomalous crop constituents, e.g. a ratio of the number of anomalous to non-anomalous crop constituents identified by the control system for a given operation.

The control system may be operable to utilise a computer implemented method for analyzing the image data to identify crop constituents therein. The computer implemented method may comprise a learned model for image data obtained from the image sensor(s). The learned model may be trained prior to implementation or use by the control system, e.g. through use of training data labelled with specific crop constituents.

The control system may be operable to employ an optical flow method for determining motion of individual crop constituents, e.g. as it passes into, through and in some instances out of the crop engaging component of the machine. The optical flow method may utilise multiple consecutive images obtained by the image sensor(s) to determine a measure of movement for individual crop constituents.

The image sensor(s) may comprise a camera. Additionally or alternatively, the image sensor(s) may comprise a transceiver type sensor, such as a LIDAR, RADAR or ultrasonics sensor. Additionally or alternatively, the image sensor(s) may comprise an infra-red or thermal camera, a time of flight (ToF) camera or the like.

The one or more operable components may comprise one or more functional components of the crop engaging component. This may include a skid plate, row unit, auger, conveyor or the like. The control system may be operable to control one or more functions of said functional components, which may comprise the operation of the component(s), an operational speed of said component(s), a relative position of features of the component(s) or the like. For example, the control system may be configured to control a spacing of skid plates or row units of the crop engaging component, or an operational speed, e.g. rotational speed of the component(s). The control system may be operable to control a cutting speed or chain speed associated with one or more row units of the crop engaging component.

The one or more operable components may comprise one or more functional components of the agricultural machine. This may include a steering and/or propulsion system of the agricultural machine for controlling motion of the machine in dependence on the determined performance metric. In some embodiments, the control system may be operable to control a propulsion and/or braking system of the agricultural machine for controlling a forward speed of the machine in dependence on the determined performance metric.

The one or more operable components may comprise a user interface of or otherwise associated with the agricultural machine. The user interface may, for example, comprise a display terminal or the like of the machine, such as a display screen in an operator cab of the machine. The user interface may instead be provided on a remote device, e.g. a tablet computer or the like operably connected to the agricultural machine. The control system may be operable to control operation of the user interface for displaying or otherwise providing information indicative of the determined performance metric to an operator of the machine.

In embodiments, the crop constituent(s) comprise crop ears. This may, in some embodiments, include cobs, such as corn cobs. The agricultural machine may comprise a harvesting machine, such as a corn harvester. The crop engaging component may comprise a header connected or mountable to the agricultural machine, such as a corn header for a corn harvester.

According to a further aspect of the invention there is provided header for a harvesting machine comprising and/or being controllable under operation of a control system as described herein.

A further aspect of the invention provides an agricultural machine comprising or being operably coupleable to the header and/or the control system of any preceding aspect.

According to a further aspect of the invention there is provided a method of monitoring operation of an agricultural machine performing an agricultural operation, comprising: receiving image data from one or more image sensors mounted on or otherwise coupled to the agricultural machine and configured to capture image data representative of the operation of a crop-engaging component of the machine; determining, from the image data, a crop parameter for each of one or more crop constituents indicative of the position and/or motion of the respective crop constituent with respect to the crop-engaging component; determining a performance metric for the agricultural operation in dependence on the determined crop parameter(s); and controlling one or more operable components associated with the agricultural machine in dependence on the determined performance metric.

The method of the present aspect of the invention may comprise performance of any one or more of the functional features of the control system of a preceding aspect discussed herein.

A further aspect of the invention comprises computer software which, when executed by one or more processors, causes performance of the method of the preceding aspect of the invention.

An aspect of the invention provides a computer readable storage medium comprising the computer software of the preceding aspect of the invention.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 is a simplified cross-sectional side view illustrating a combine harvester embodying aspects of the present disclosure;

FIG. 2 is a schematic perspective view of a corn header;

FIG. 3 is a schematic diagram illustrating an embodiment of a control system of the present disclosure;

FIG. 4 is a flowchart illustrating an embodiment of a method of the present disclosure; and

FIG. 5 is a simplified schematic view of a corn header illustrating the operational use of embodiments of the disclosure.

### DETAILED DESCRIPTION

Systems and methods are provided for monitoring operation of an agricultural machine (e.g. a harvester 10) performing an agricultural operation (e.g. a harvesting operation) in a working environment such as a field. Image data from one or more image sensors (e.g. cameras 29) mounted on or otherwise coupled to the harvester 10 is obtained and used to monitor operation of a header 16 operably coupled to the harvester 10. Image data from the camera 29 is used determine a crop parameter for each of one or more crop constituents indicative of the position and/or motion of the respective crop constituent with respect to the header 16. The crop parameter can include the position, motion and size or shape of the crop constituents, for example. Crop constituents may include, in an example, corn cobs. A performance metric for the agricultural operation is determined in dependence on the determined crop parameter(s) which, in embodiments, quantifies the performance of the operation, e.g. in terms of a measure of loss associated with the operation-see below. One or more operable components associated with the harvester 10 can then be controlled in dependence on the determined performance metric. The operable component(s) may include functional components of the header 16, a user interface 32 associated with the harvester 10 and/or operation of the harvester 10 itself, e.g. through control over a propulsion, braking and/or steering system of the harvester 10 in the manner described hereinbelow.

### Harvester

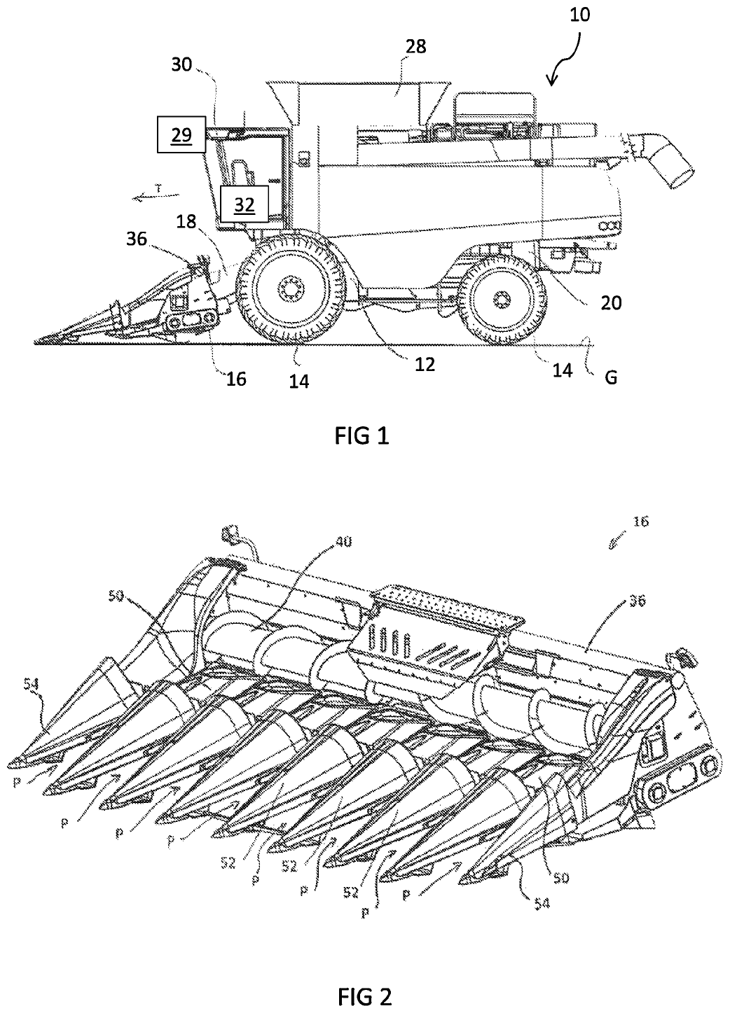

FIG. 1 illustrates an agricultural harvester 10, which includes a chassis 12 supported and propelled along the ground G by ground-engaging wheels 14. Although the harvester 10 is illustrated as being supported and propelled on ground-engaging wheels 14, the harvester 10 can also be supported and propelled by full tracks or half tracks. A harvesting header 16 carried by the chassis 12 is used to gather crop and to conduct the crop material to a feederhouse 18 and then to a beater in the harvester 10. The beater guides the crop upward to a threshing and separating system 20, which is configured to separate grain from material other than grain (MOG), and deliver the grain to a grain tank 28 carried by the harvester 10. The operation of the harvester 10 is controlled from an operator cab 30. A user interface 32 is provided within the operator cab 30 for displaying or otherwise providing information to an operator of the harvester 10 data indicative of the operation of the harvester 10 or other associated components, e.g. the header 16. The harvester 10 is additionally provided with an imaging sensor in the form of camera 29 mounted thereto and configured to obtain image data representative of the header 16 for monitoring its operation in the manner discussed herein.

FIG. 2 is a simplified perspective view of the harvesting header 16, which is a corn header. The illustrated corn header includes a header frame 36 carrying an auger 40 and eight row units 50. The row units 50 are separated by seven row dividers 52 and surrounded by end dividers 54. Ears of corn are stripped from each of eight crop rows planted along row paths P by the row units 50 and then carried by the auger 40 toward the feederhouse 18 of the harvester 10. Harvesting corn in a harvester 10 is described generally in U.S. Pat. No. 9,322,629, “Stalk Sensor Apparatus, Systems, and Methods,” issued Apr. 26, 2016.

### Control System

As discussed herein, a control system 100 is provided and configured to controlling operation of one or more operable components (e.g. header control unit 120, harvester control unit 130, and/or user interface 32) associated with the harvester 10. In the illustrated embodiment the controllable components include a header control unit 120 for controlling functional features of the header 16, a harvester control unit 130 for controlling operational parameters of the harvester 10, e.g. a forward speed or path, and the user interface 32, here provided as a display terminal provided within the operator cab 30 of the harvester 10, and is utilised to provide an indication of the operation of the control system 100 and/or to receive one or more operator inputs for controlling operation of the control system 100 or associated components in the manner described herein.

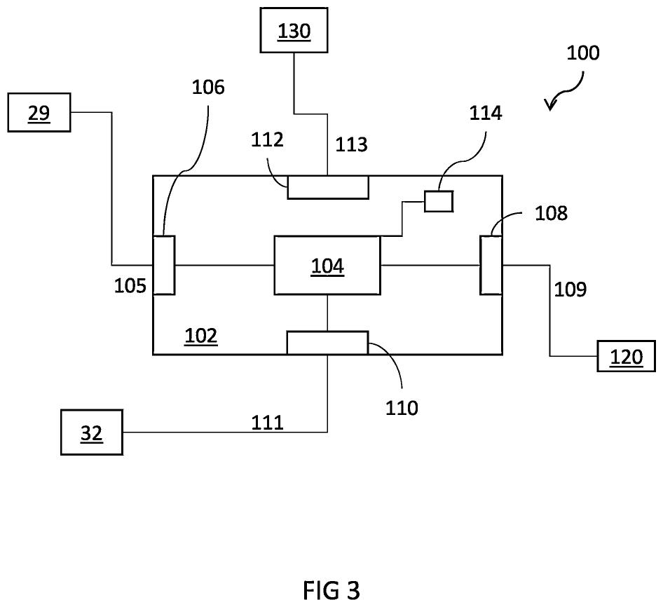

FIG. 3 illustrates the control system 100 further. As shown, control system 100 comprises a controller 102 having an electronic processor 104, electronic input 106 electronic outputs 108, 112 and electronic input/output 110. The processor 104 is operable to access a memory 114 of the controller 102 and execute instructions stored therein to perform the steps and functionality of the present invention discussed herein, e.g. by controlling operation of functional components of the header 16 in dependence on a performance metric as determined by the control system 100, and/or controlling the user interface 32 to display information indicative of determined performance metric and/or to receive an operator input for initiating control actions based on the determined performance metric, through generation and output of one or more control signals.

The processor 104 is operable to receive via input 106 which, in the illustrated embodiment, takes the form of input signals 105 received from a control unit associated with camera 29 associated with the harvester 10, image data representative of the operation of the header 16. The processor 104 is configured to analyse the image data and determine therefrom a crop parameters for each of one or more crop constituents in the manner discussed herein, e.g. using a trained model for identifying the position and/or motion or respective crop constituents with respect to the header 16. The processor 104 is further configured to utilise the determined crop parameter(s) to determine a performance metric for the operation being performed by the harvester 10. In embodiments, the performance metric quantifies performance of the operation and is preferably a measure of ground loss for the operation, as discussed herein.

As described above, the controller 102 includes an electronic output 108 configured to output control signals 109 generated by the processor 104 for controlling operation of one or more operable components associated with the header 16. Specifically, in the illustrated embodiment, the processor 104 is operable to generate, and the controller 102 operable then to output via output 108, control signals 109 to local control unit 120 of the header 16 for controlling operable parameters thereof in dependence on the determined performance metric. In practice, this may include adjusting an operation of operable components of the header 16, an operational speed of said component(s) and a relative position of the component(s). This can include a cutting speed or chain speed of one or more of the row units 50, and/or a separation distance between adjacent row units 50.

Controller 102 additionally includes an electronic output 112 for outputting control signals 113 to a control unit 130 associated with the harvester 10. In turn, said control unit 130 may be operable to control operation of one or more of a steering system, braking system and/or propulsion system of the harvester 10 for controlling motion of the harvester 10 in dependence on the performance metric determined in the manner described herein. In practice, this may include control over a forward speed and/or operational path for the harvester 10.

Input/output 110 is operably connected to user interface 32. The control system 100 is operable to control operation of the user interface 32, e.g. through output of control signals 111 in order to display data to an operator of the harvester 10 indicative of the performance metric, as determined by processor 104. This can include simply providing an indication to the operator of the determined performance metric, e.g. the determined ground loss, or prompt the operator to initiate one or more actions for reducing or minimizing the ground loss. In response to an operator input, further actions may be taken by the control system 100 according to the input, e.g. for controlling operation of the harvester 10 and/or header 16 specifically via local control units 120, 130. For this purpose, the input/output 110 is additionally configured to receive input signals 111 from the user interface 32 indicative of an operator input at the user interface 32.

### Method

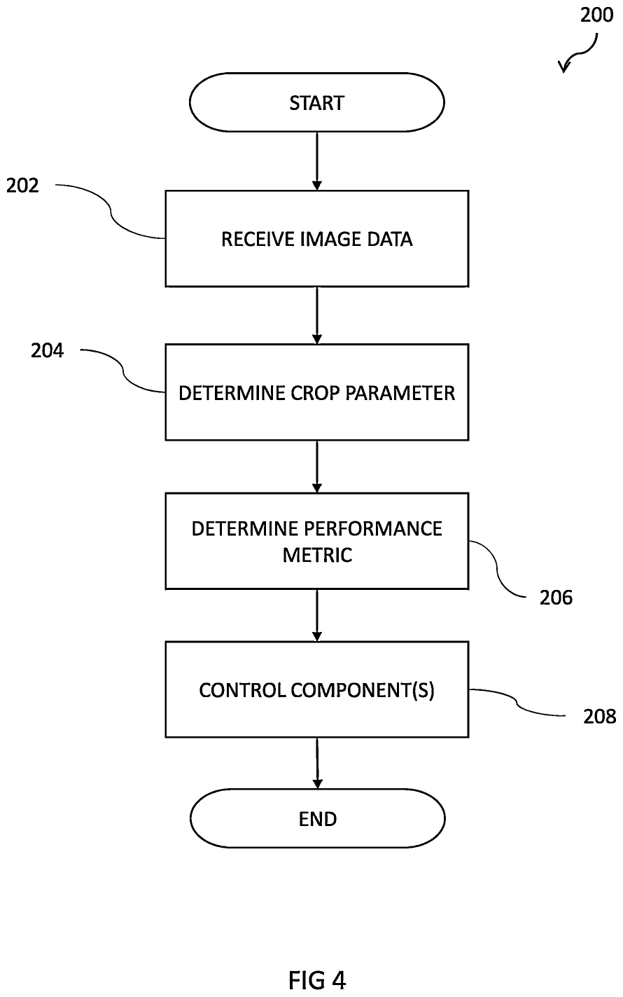

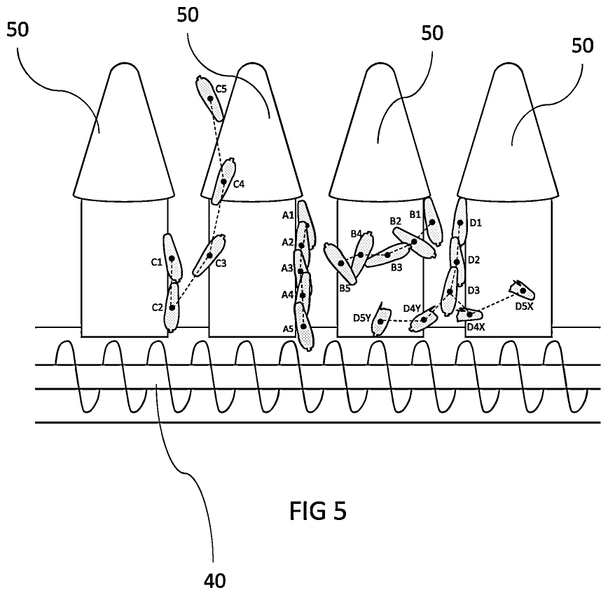

FIG. 4 illustrates a method 200 in accordance with the present disclosure. Method 200 comprises, at step 102, receiving image data from one or more image sensors (here camera 29) mounted to the harvester 10 and operable, in use, to capture image data representative of the operation of a crop engaging component (here the header 16) of or otherwise associated with the harvester 10. As shown herein, the camera 29 is mounted on the operator cab 30 of the harvester 10 and is directed such that the field of view of the camera 29 encompasses the header 16 and the crop material flowing into and through the header 16, in use.

At step 204, a crop parameter for each of one or more crop constituents is determined, with the crop parameter(s) being indicative of the position and/or motion of the respective crop constituent with respect to the header 16 or components thereof. In the illustrated embodiment the header 16 comprises a corn header for use in harvesting corn, and the crop constituents comprise corn cobs.

The crop parameter(s) is determined through analysis of the image data received from camera 29. Specifically, an object detection algorithm is employed to identify individual crop constituents from the image data. Here, this comprises use of a trained model for the process, trained using training data having a plurality of images and known positions of corn cobs in those images.

In embodiments the crop parameter(s) comprises a measure of movement of the identified crop constituents with respect to the header 16. Here, analysis of consecutive images obtained by the camera 29 is used to track motion of each of one or more crop constituents with respect to the header 16. From this, a measure of a motion parameter is determined, and can include a direction and/or speed of motion for each of the crop constituent(s).

FIG. 5 illustrates multiple different paths followed by crop constituents, here corn cobs A, B, C, D as they travel into and through a header 16 in engagement with components thereof, specifically the row units 50, with the subscripts 1, 2, 3, etc. denoting the sequence of positions for each of the cobs. In the illustrated example, corn cob A follows an expected path for corn cobs as it travels into and through the header 16 towards the auger 40 thereof. As can be seen in FIG. 5, this motion is substantially straight through the header 16, with the cob A travelling straight towards and into the auger 40 for collection by the harvester 10. This is considered to be the “normal” or “good” scenario and is desirable for all cobs. As discussed herein, this can be termed an “expected path” for the corn cobs and used as a marker for determining an anomalous cob in dependence on its travelled path with respect to the expected path.

Corn cob B is shown to travel between row units 50. Here, cob B has been squeezed or impacted in a manner once coming into engagement with the header 16 in a manner which has deflected its path across the header 16 rather than towards the auger 40 along an expected path. Whilst corn cob B could subsequently be collected by the adjacent row unit 50, a measure of the number of cobs following a comparable path can be indicative of a ground loss experienced by the header 16.

Corn cob C initially follows an expected path, but is somehow squeezed or impacted in a manner where there is an abrupt change in direction of travel for the cob C, here indicative of the cob C jumping up and out of the header 16 altogether, ending up on the ground rather than being collected by the harvester 10. Accordingly, a measure of the number of cobs following a comparable path is directly indicative of a ground loss experienced by the header 16.

Similarly, corn cob D initially follows an expected path, but in this instance is shown to be squeezed or impacted in a manner which ends with the cob D splitting into two parts—Dx and Dy. Here, this illustrates a further crop parameter being determined as per the present disclosure, being the size and/or shape of the cobs, and specifically a change therein, as it passes into and through the header 16. Broken cobs can leas directly to grain damage and hence overall loss by the harvester 10, however in addition broken cobs are more likely to be dislodged and jump out of the header 16 thereby directly contributing to a ground loss for the harvester 10.

Each of corn cobs B, C, D are identified as anomalous crop constituents, and a count thereof can be used to determine a performance metric for the operation in the manner discussed herein.

Specifically, at step 206, a performance metric for the harvesting operation is determined. In an embodiment, the performance metric quantifies a loss experienced during the harvesting process, and specifically a ground loss. In the illustrated embodiment this comprises an absolute count of the number of anomalous crop constituents identified compared with a base value, here a measure of the yield for the process, for determining a relative ground loss for the process. The user may define an appropriate or acceptable relative loss for the operation, and the control system 100 and method 200 described herein may be used or may monitor the performance metric against this level to determine whether any preventative or corrective actions need to take place. In turn, this controls performance of the final step (step 208) of method 200 whereby one or more operable components associated with the harvester 10 are controlled based on the performance metric.

Specifically, at step 208, control over the operable component(s) is used to minimize or at least partly reduce the ground loss experienced during performance of the harvesting operation.

Here, this includes adjusting a forward speed for the harvester 10 to reduce (or increase) a volume of crop material entering the header 16. For example, for high levels of ground loss it may be desirable to reduce a forward speed of the harvester 10 to reduce the volume of crop material entering the header 16. In contrast, this is balanced by the forward speed having a direct effect on the efficiency (in time) for the overall operation. In practice, adjusting a forward speed of the harvester 10 includes control over a braking and/or propulsion system of the harvester 10, e.g. via local control unit 130.

In addition, the operable component(s) can include functional components of the header 16 itself. For example, the separation distance between adjacent row units 50 may be increased to prevent or reduce incidence of cobs being squeezed and potentially split (see cob D in FIG. 5). It may include controlling an operational speed of components of the header 16, for example, to reduce incidence of cobs being ejected from the header 16 due to higher energy impacts of cobs with said functional components. This can include a cutting or chain speed of the row units 50, for example.

Further, operable component(s) can, in embodiments, include control over the user interface 32 in the manner discussed herein. For example, controlling the user interface 32 to display or otherwise present to the operator an indication of a level of ground loss measured by the control system 100 or through performance of method 200.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

1. A control system for monitoring operation of an agricultural machine performing an agricultural operation, the control system comprising one or more controllers, and being configured to:
receive image data from one or more image sensors mounted on or otherwise coupled to the agricultural machine and configured to capture image data representative of the operation of a crop-engaging component of the machine;
determine, from the image data, a crop parameter for each of one or more crop constituents indicative of the position and/or motion of the respective crop constituent with respect to the crop-engaging component;
determine a performance metric for the agricultural operation in dependence on the determined crop parameter(s); and
generate and output control signals for controlling one or more operable components associated with the agricultural machine in dependence on the determined performance metric.

2. A control system as claimed in claim 1, configured to analyze the image data from the one or more image sensors and identify therein one or more individual crop constituents.

3. A control system as claimed in claim 1, wherein the crop parameter comprises a position of the crop constituent(s).

4. A control system as claimed in claim 1, wherein the crop parameter comprises a measure of a movement of the crop constituent(s).

5. A control system as claimed in claim 4, wherein the measure of the movement of the crop constituent(s) comprises a measure of the direction, speed and or distance of travel of the crop constituent(s).

6. A control system as claimed in claim 4, configured to determine whether a path travelled by a crop constituent follows an expected path for the operation and/or the particular crop engaging component.

7. A control system as claimed in claim 6, configured to identify an anomalous crop constituent in dependence on a measure of movement for that constituent deviating from the expected path for the monitored agricultural operation or crop engaging component.

8. A control system as claimed in claim 1, wherein the crop parameter comprises a size of the crop constituent(s); and wherein the control system is configured to analyze the image data and determine or identify therefrom a change in size of the crop constituent(s) during the collection/harvesting of the crop constituent(s) by the agricultural machine

9. A control system as claimed in claim 8, configured to compare the identified change in size with a threshold and determine an anomalous constituent in dependence on the comparison.

10. A control system as claimed in claim 1, wherein the performance metric corresponds to a measure of ground loss for the agricultural operation.

11. A control system as claimed in claim 1, operable to utilize a computer implemented method for analyzing the image data to identify crop constituents therein, the computer implemented method comprising a learned model for image data obtained from the image sensor(s).

12. A control system as claimed in claim 1, wherein the one or more operable components comprise one or more functional components of the crop engaging component including one or more of: a skid plate, a row unit, an auger, and a conveyor.

13. (canceled)

14. A control system as claimed in claim 12, operable to control one or more functions of said functional components, including one or more of: the operation of the component(s); an operational speed of said component(s); and a relative position of features of the component(s).

15. A control system as claimed in claim 12, operable to control a cutting speed or chain speed associated with one or more row units of the crop engaging component.

16. A control system as claimed in claim 1, wherein the one or more operable components comprise one or more functional components of the agricultural machine comprising one or more of: a steering system; a braking system and/or a propulsion system of the agricultural machine for controlling motion of the machine in dependence on the determined performance metric.

17. (canceled)

18. A control system as claimed in claim 1, wherein the one or more operable components comprise a user interface of or otherwise associated with the agricultural machine.

19. A header for a harvesting machine comprising and/or being controllable under operation of the control system of claim 1.

20. An agricultural machine comprising or being operably coupleable to the header of claim 19.

21. A method of monitoring operation of an agricultural machine performing an agricultural operation, comprising:
receiving image data from one or more image sensors mounted on or otherwise coupled to the agricultural machine and configured to capture image data representative of the operation of a crop-engaging component of the machine;
determining, from the image data, a crop parameter for each of one or more crop constituents indicative of the position and/or motion of the respective crop constituent with respect to the crop-engaging component;
determining a performance metric for the agricultural operation in dependence on the determined crop parameter(s); and
controlling one or more operable components associated with the agricultural machine in dependence on the determined performance metric.

22. An agricultural machine comprising or being operably coupleable to the control system of claim 1.
